(19) United States
(12) Patent Application Publication
(10) Pub. No.: US 2016/0288698 A1
(43) Pub. Date: Oct. 6, 2016

(54) method and device for ascertaining a safety angle of a headlight beam of at least one headlight of a vehicle

(71) Applicant: ROBERT BOSCH GMBH, Stuttgart (DE)

(72) Inventor: Johannes FOLTIN, Ditzingen (DE)

(21) Appl. No.: 14/912,349

(22) PCT Filed: Jul. 23, 2014
(86) PCT No.: PCT/EP2014/065790

§ 371 Date: Jun. 22, 2016

(30) Foreign Application Priority Data
Aug. 26, 2013 (DE) 10 2013 216 904.3

(51) Int. Cl. B60Q 1/10; B60Q 1/08

(52) U.S. Cl. CPC B60Q 1/10; B60Q 1/085; B60Q 2300/112; B60Q 2300/132

(57) ABSTRACT

In a method for ascertaining a safety angle of a headlight beam of at least one headlight of a vehicle, which safety angle represents a vertical angle by which the headlight beam is lowered to a safety height, which safety height represents a height of the headlight beam at which no blinding of a driver of another vehicle occurs, a speed value is read in in a first step, which speed value is a function of a speed of the vehicle, and the safety angle is ascertained in a second step, using the speed value.

### BACKGROUND OF THE INVENTION

1. Field of the Invention

The present invention relates to a method for ascertaining a safety angle of a headlight beam of at least one headlight of a vehicle, a corresponding device, and a corresponding computer program product.

2. Description of the Related Art

With the aid of recent headlight systems such as adaptive headlight control or AHC for short (adaptive high beam assistant), a range of a headlight of a vehicle may be adapted to a position of other road users with respect to the vehicle.

A beam angle of the headlight may change due to unevennesses of the road. This may result in the blinding of other road users. Therefore, recent headlight systems use a safety angle, which is intended to prevent flashing of the headlight and blinding. The safety angle may be adapted to a road quality, for example. In comparison to a fixed safety angle, it is thus possible, depending on the road quality, to increase an average visual range or reduce the blinding. A small safety angle may be selected for good road quality, and a large safety angle may be selected for poor road quality.

The road quality is generally ascertained over a fairly long period of 20 seconds, for example. Rapid changes in the road quality therefore become noticeable only slowly, in the form of a change in the safety angle. A quick response maybe achieved, for example, via a weighting of a required safety angle as a function of how recently the road quality was measured.

### BRIEF SUMMARY OF THE INVENTION

Against this background, an improved method for ascertaining a safety angle of a headlight beam of at least one headlight of a vehicle, a corresponding device, and a corresponding computer program product are provided with the present invention.

A method for ascertaining a safety angle of a headlight beam of at least one headlight of a vehicle is provided. The safety angle may represent in particular a vertical angle by which the headlight beam is lowered to a safety height. The safety height may represent a height of the headlight beam at which no blinding of a driver of another vehicle occurs. The method includes the following steps:

reading in a speed value, the speed value being a function of a speed of the vehicle; and

ascertaining the safety angle, using the speed value.

The at least one headlight may be, for example, a front headlight of the vehicle. The at least one headlight may be designed for emitting a headlight beam for illuminating the surroundings of the vehicle. The surroundings may be an area ahead of the vehicle, for example. A headlight beam may be understood, for example, to mean a light cone of a high-beam light . The headlight beam may be lowered by a safety angle to a safety height. The safety angle may be a variable vertical inclination angle of the at least one headlight by which the at least one headlight may be adjusted in order to prevent blinding of other road users. A safety height may be understood to mean a height setting of the at least one headlight for which an illumination range of the headlight beam is reduced in such a way that other road users are not blinded. The safety height may be influenced by the safety angle: the larger the safety angle, the lower the safety height, i.e., the steeper an angle at which the headlight beam strikes a road for the vehicle. A speed value may be understood, for example, to mean a signal which is provided by an appropriate sensor of the vehicle. The speed value may represent an instantaneous speed of the vehicle or an instantaneous relative speed of the vehicle with respect to another vehicle, for example a preceding or oncoming vehicle.

The present approach is based on the finding that a switched-on headlight of a vehicle may cause flashing when the vehicle travels over unevennesses of the road such as bumps, for example. Other road users may be blinded by the flashing. The flashing may have a more disturbing effect the faster the vehicle travels over the unevennesses of the road, i.e., the more intense the pitching motions of the vehicle which are caused by the unevennesses of the road. To avoid the flashing, a headlight beam of the headlight may be lowered by a safety angle to a blind-free height, also referred to as the safety height. The safety angle maybe adapted to a degree of the unevenness of the road, which may also be referred to as the road quality. A certain measuring period is necessary to ascertain the road quality. However, a speed of the vehicle, and thus also an influence of the unevenness of the road on the pitching motions and thus on the headlight beam, may change during the measuring period. The ascertained safety angle may then be too small or too large, so that other road users are blinded or a visual range of the driver is excessively reduced. The present approach provides a method in which the safety angle is adapted as a function of a speed of the vehicle. The safety angle may thus be adapted much more quickly, so that other road users are not blinded or at least are blinded less intensely, and the visual range of the driver is not unnecessarily limited.

The present approach may advantageously be integrated very cost-effectively into conventional high beam assistant systems, such as AHC, with little technical effort.

According to one specific embodiment of the present approach, the method may include a step of determining a reference value, using a pitch angle of the vehicle. The safety angle may also be ascertained in the step of ascertaining, using the reference value. A pitch angle may be understood to mean an angle of rotation of the vehicle about a transverse axis of the vehicle. For example, the pitch angle of the vehicle may change while traveling over unevennesses of the road such as bumps or speed bumps. The pitch angle may be used to determine a reference value for ascertaining the safety angle. For example, the pitch angle may be detected particularly easily with the aid of sensors of the vehicle which are present. By use of the reference value, the safety angle may be adapted very precisely to a condition of the road for the vehicle.

When the vehicle travels over an unevenness of the road which is more pronounced on one side of the vehicle than on the other side, different pitching motions result for each side of the vehicle. The pitching motions, which differ in intensity, may be measured as a roll angle or roll rate, which likewise may be utilized for ascertaining the safety angle.

According to one specific embodiment of the present approach, the reference value may be linked to the speed value, in particular multiplied by and/or weighted with the speed value, in the step of ascertaining in order to ascertain the safety angle. A response period when adapting the safety angle to a changed speed may thus be significantly shortened. Particularly cost-effective standard components may advantageously be used for linking the reference value to the speed value.

According to one specific embodiment of the present approach, the reference value may also be determined in the step of determining, using a pitch rate and/or a change in pitch angle of the vehicle. A pitch rate may generally be understood to mean a variable which indicates by how many degrees the pitch angle of the vehicle changes per unit of time, for example per second. A change in pitch angle may be understood to mean a variable which indicates by how many degrees the pitch angle changes within a predetermined time period. As a result of the reference value also being determined, using the pitch rate and/or change in pitch angle, very high reliability in detecting the road condition may be ensured at low cost.

According to one specific embodiment of the present approach, a further speed value may be read in in the step of reading in. The further speed value may represent a further speed of the vehicle. The reference value may also be linked to the further speed value, in particular normalized to the further speed value, in the step of determining. A reference value which is normalized to the further speed value may be understood to mean a variable which indicates by how many degrees the pitch angle of the vehicle changes per unit of length, for example per meter. The normalized reference value may be multiplied by the speed value in the step of ascertaining, for example, in order to adapt the reference value to an instantaneous speed of the vehicle. As a result of normalizing the reference value to the further speed value, the safety angle may be adapted very quickly and very accurately to a speed of the vehicle and also to the road condition.

According to one specific embodiment of the present approach, the reference value may also be determined in the step of determining, using a plurality of base values which are detected during a predetermined time period and which are a function of the pitch angle. A predetermined time period may be understood, for example, to mean a storage capacity of a buffer, which may be designed for reading in the base values, which are a function of the pitch angle, for a period of 5, 10, 20, or 30 seconds, for example, and storing them.

A base value maybe a signal of a sensor of the vehicle, the signal representing a pitch angle of the vehicle. The base values may differ from one another. For example, the reference value may represent an average value of the base values which is determined from the plurality of base values. A computing time for determining the reference value may be significantly reduced by ascertaining the reference value at certain time intervals. As a result, cost-effective standard components maybe used. Since the reference value may be determined from a plurality of different base values, the reference value still has high accuracy.

According to one specific embodiment of the present approach, the safety angle may also be ascertained in the step of ascertaining, taking into account a minimum safety angle and/or a maximum safety angle and/or a minimum speed value and/or a maximum speed value. Excessively large differences during determination of the safety angle, for example due to measuring inaccuracies, may thus be avoided.

Moreover, the present approach provides a device for ascertaining a safety angle of a headlight beam of at least one headlight of a vehicle. The safety angle may in particular represent a vertical angle by which the headlight beam is lowered to a safety height. The safety height may represent a height of the headlight beam at which no blinding of a driver of another vehicle occurs. The device has the following features:

a reading-in unit for reading in a speed value, the speed value being a function of a speed of the vehicle; and

an ascertainment unit for ascertaining the safety angle, using the speed value.

In the present context, a device may be understood to mean an electrical device which processes sensor signals and outputs control and/or data signals as a function thereof. The device may include an interface which may have a hardware and/or software design. In a hardware design, the interfaces may be part of a so-called system ASIC, for example, which contains various functions of the device. However, it is also possible for the interfaces to be dedicated, integrated circuits, or to be at least partially made up of discrete components. In a software design, the interfaces may be software modules which are present on a microcontroller, for example, in addition to other software modules. In addition, the object underlying the approach may be quickly and efficiently achieved by this embodiment variant of the approach provided here.

Also advantageous is a computer program product having program code which may be stored on a machine-readable carrier such as a semiconductor memory, a hard disk, or an optical memory, and used for carrying out the method according to one of the specific embodiments described above when the program product is executed on a computer or a device.

The present invention is explained in greater detail below with reference to the appended drawings.

### BRIEF DESCRIPTION OF THE DRAWINGS

FIG. 1 shows a block diagram of a device for determining a safety angle according to one exemplary embodiment of the present invention.

FIG. 2 shows a schematic illustration of various driving situations of a vehicle with switched-on headlights

FIG. 3 shows a schematic illustration of a vehicle with switched-on headlights on an uneven road

FIGS. 4a, 4b show schematic illustrations of a pitch angle curve of a vehicle at low and high speeds

FIGS. 5a, 5b show schematic illustrations of a pitch rate of a vehicle at low and high speeds

FIG. 6 shows a schematic illustration of a pitch angle curve and a safety angle curve of a vehicle for different speeds and road qualities, according to a conventional method for ascertaining a safety angle

FIG. 7 shows a schematic illustration of a pitch angle curve and a safety angle curve of a vehicle for different speeds and road qualities, according to one exemplary embodiment of the present invention

FIG. 8 shows a flow chart of a method for ascertaining a safety angle according to one exemplary embodiment of the present invention.

FIG. 9 shows a flow chart of a method for ascertaining a safety angle according to one exemplary embodiment of the present invention.

### DETAILED DESCRIPTION OF THE INVENTION

In the following description of advantageous exemplary embodiments of the present invention, identical or similar reference numerals are used for the elements having a similar action which are illustrated in the various figures, and a repeated description of these elements is dispensed with.

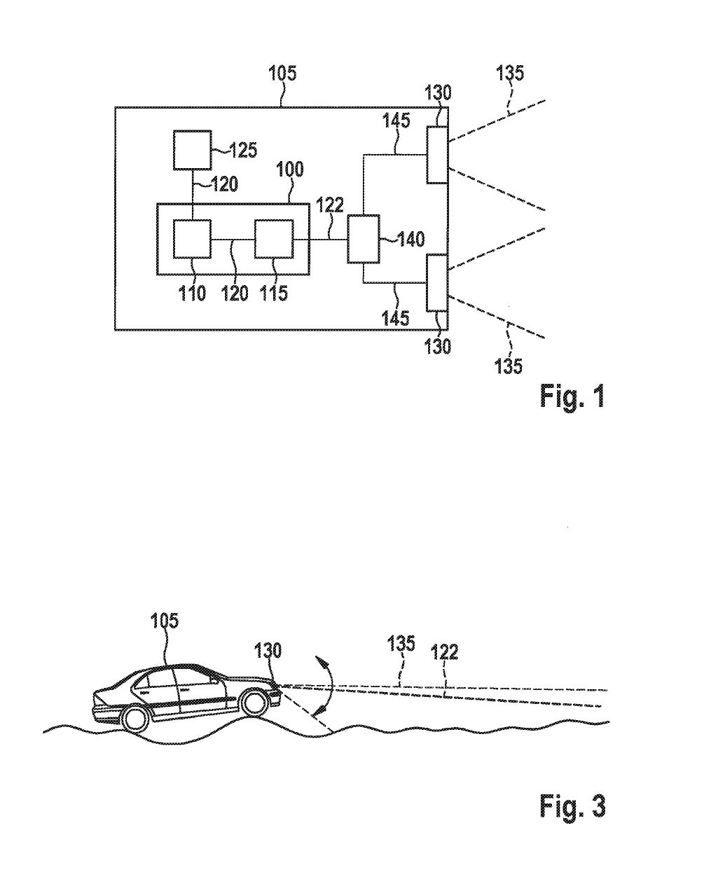

FIG. 1 shows a block diagram of a device 100 for determining a safety angle according to one exemplary embodiment of the present invention. Device 100 is situated in a vehicle 105. Device 100 includes a reading-in unit 110 and an ascertainment unit 115. Reading-in unit 110 is designed for reading in a speed value 120, speed value 120 representing a speed of vehicle 105 or at least being a function of a speed of vehicle 105. Reading-in unit 110 and ascertainment unit 115 are connected to one another. Reading-in unit 110 is also designed for outputting speed value 120 to ascertainment unit 115. Ascertainment unit 115 is designed for receiving speed value 120. In addition, ascertainment unit 115 is designed for ascertaining a safety angle 122, using speed value 120. Speed value 120 maybe detected, for example, by a speed sensor 125 of vehicle 105. Speed sensor 125 maybe connected to reading-in unit 110 via an interface of device 100 and designed for outputting speed value 120 to reading-in unit 110. Ascertainment unit 115 may be designed, for example, for outputting safety angle 122, in the form of a corresponding signal, to a further interface of device 100.

Vehicle 105 has two headlights 130. Headlights 130 may be front headlights of vehicle 105. Headlights 130 are each designed for emitting a headlight beam 135 for illuminating an area ahead of vehicle 105. Headlight beam 135 may be, for example, a high-beam light of vehicle 105.

Vehicle 105 may be equipped with an optional control unit 140 for controlling headlights 130. Control unit 140 may be connected to headlights 130. In addition, control unit 140 may be connected to ascertainment unit 115 via the further interface of device 100. Control unit 140 may be designed for reading in the signal which represents safety angle 122, and providing appropriate control signals 145 for controlling headlights 130, using safety angle 122. Headlights 130 may be designed for lowering each headlight beam 135 by safety angle 122 to a safety height in response to receiving control signals 145. Thus, for example, blinding of a driver of a vehicle (not illustrated) preceding or approaching vehicle 105 may be prevented.

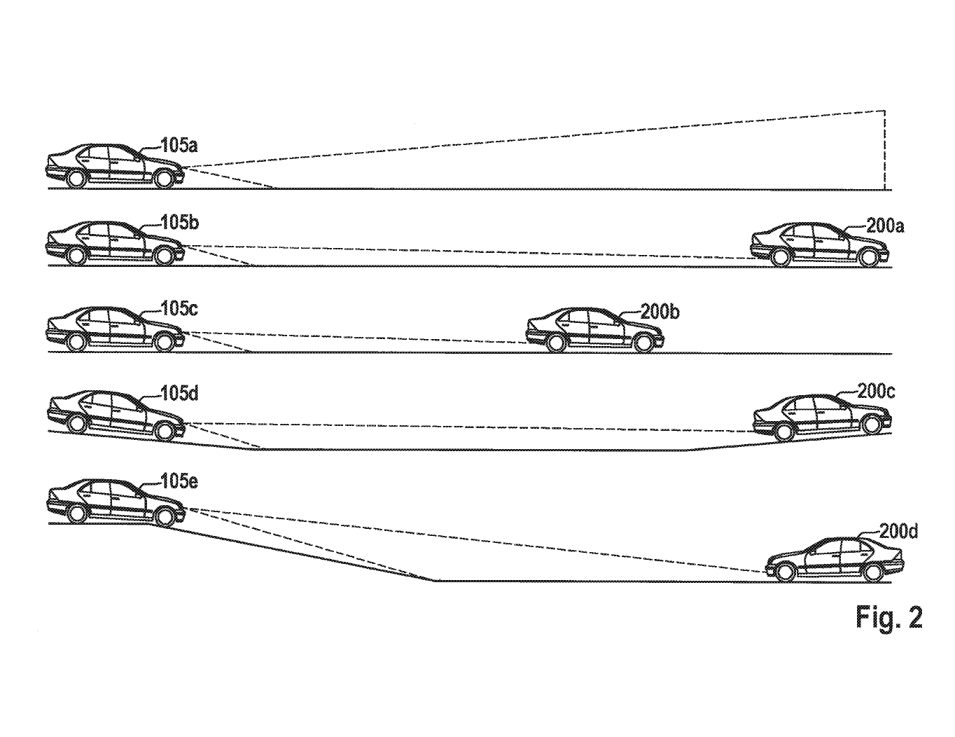

FIG. 2 shows a schematic illustration of various driving situations of a vehicle 105 with switched-on headlights 130.

In a first driving situation, vehicle 105a is traveling alone on a flat road. The road is illuminated over its entire length by the headlight beam of vehicle 105a, for example a high-beam light. The high-beam light may be controlled, for example, by a high beam assistant such as AHC. The headlight beam has no safety angle, or at least has a very small safety angle.

In a second driving situation, another vehicle 200a is traveling at a large distance ahead of vehicle 105b. Other vehicle 200a may be detected, for example, by an optional surroundings detection device of the high beam assistant. In response to the detection of other vehicle 200a, device 100 shown in FIG. 1 maybe activated in order to lower the headlight beam of vehicle 105b by the safety angle to a safety height, as a function of a speed of vehicle 105b. The headlight beam is lowered far enough that a driver of other vehicle 200a is not blinded by the headlight beam.

In a third driving situation, the distance between vehicle 105c and other vehicle 200b is less than in the second driving situation. For example, the distance may be reduced due to an increase in a relative speed between vehicle 105c and other vehicle 200b. According to one exemplary embodiment of the present invention, the headlight beam has a larger safety angle than in the second driving situation, corresponding to the increased speed value, so that the headlight beam is lowered further in the direction of the road.

In a fourth driving situation, other vehicle 200c is traveling at a large distance ahead of vehicle 105d. The distance corresponds to the distance illustrated in the second driving situation. In contrast to the second driving situation, the road for vehicle 105d has a slight downhill grade, and the road for other vehicle 200c has a slight uphill grade. Thus, other vehicle 200c is situated at a higher road level than vehicle 105d. A pitch angle of vehicle 105d is changed due to the downhill grade. A change in pitch angle may be detected, for example, with the aid of a sensor of vehicle 105d. According to one exemplary embodiment of the present invention, the safety angle may be adapted to an inclination angle of the downhill grade, using the change in pitch angle. For example, the speed of the vehicle may also change while descending the downhill grade. A change in speed may also be taken into account when adapting the safety angle. Due to the inclination of vehicle 105d, the headlight beam has a smaller safety angle than in the second driving situation.

In a fifth driving situation, other vehicle 200d is approaching vehicle 105e from a large distance. The distance between vehicle 105e and other vehicle 200d corresponds to the distance illustrated in the second and fourth driving situations. In addition, vehicle 105e is situated at a higher road level than other vehicle 200d. Vehicle 105e is at the start of a downhill grade. Vehicle 105e thus has a smaller inclination than in the fourth driving situation. Similarly to the fourth driving situation, the safety angle of the headlight beam is adapted to the change in pitch angle of vehicle 105e resulting from the downhill grade. Also in the fifth driving situation, the safety angle may be smaller than in the second driving situation, despite the same distance between the vehicles, in order to not blind the driver of other vehicle 200d.

FIG. 3 shows a schematic illustration of a vehicle 105 with switched-on headlights 130 on an uneven road. While traveling over the uneven road, vehicle 105 experiences pitching motions about a transverse axis of vehicle 105. The directions of the pitching motions are illustrated by a double arrow. Headlight 130 is situated for illuminating an area ahead of vehicle 105. Due to the pitching motions, a pitch angle of vehicle 105, and thus a beam angle of headlight beam 135 emitted from headlight 130, changes. In the process, the pitching motions may cause flashing. By use of a method according to one exemplary embodiment of the present invention, with the aid of safety angle 122 the inclination of headlight beam 135 may be adapted to a degree of unevenness of the road and to a speed of vehicle 105 in order to avoid blinding other road users.

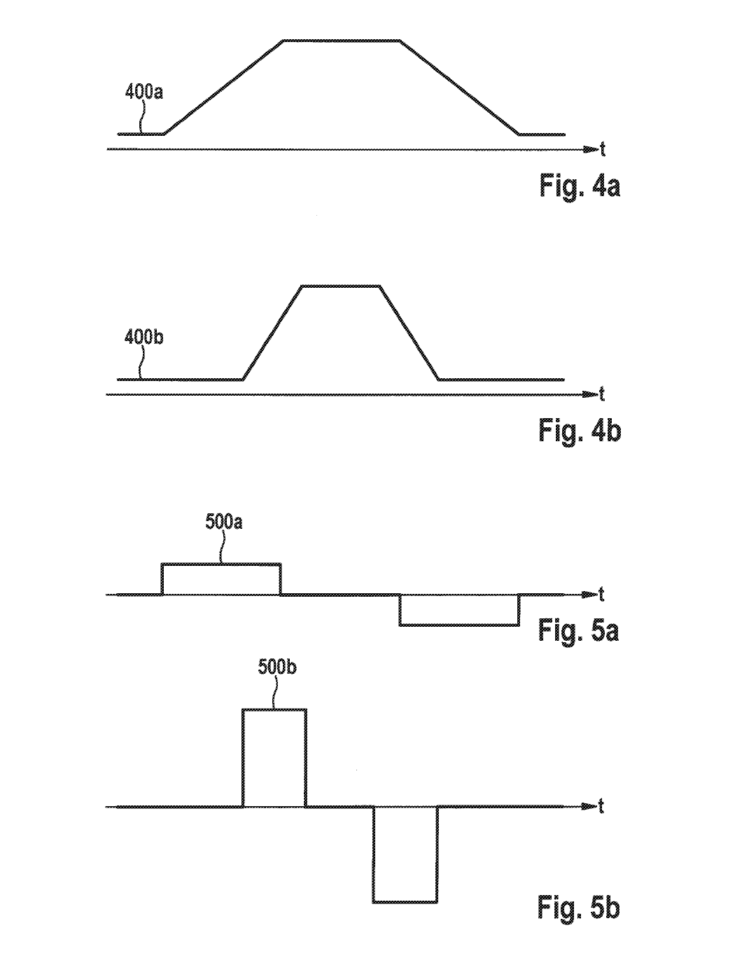

FIGS. 4a, 4b show schematic illustrations of a pitch angle curve 400 of a vehicle at low and high speeds.

FIG. 4a shows a pitch angle curve 400a of the vehicle at low speed. Pitch angle curve 400a corresponds to a change in the pitch angle of the vehicle caused, for example, by traveling over a bump. At the start of pitch angle curve 400a, the pitch angle is constant. The pitch angle has a low initial value which corresponds to travel of the vehicle on a flat road. When the vehicle travels over the bump, the pitch angle initially increases linearly. Upon passing the highest point of the bump, the pitch angle reaches a maximum value which is much higher than the initial value. The maximum value remains constant during a certain time period. When the vehicle has traveled over the highest point of the bump, the pitch angle drops linearly back to the initial value and remains constant at this value. The vehicle is now once again on a flat road.

FIG. 4b shows a pitch angle curve 400b of the vehicle at high speed. For example, the speed of pitch angle curve 400b may be twice as high as the speed of pitch angle curve 400a. The phases of the linear rising and falling of the pitch angle as well as the phase of the maximum value are half as long in pitch angle curve 400b as in pitch angle curve 400b. The maximum value shown in FIG. 4b is also identical to the maximum value shown in FIG. 4a.

FIGS. 5a, 5b show schematic illustrations of a pitch rate of a vehicle at low and high speeds.

FIG. 5a shows a pitch rate 500a of the vehicle at low speed. Pitch rate 500a has a step-like curve. Pitch rate 500a has an initial value of zero as long as the pitch angle of the vehicle is constant. When the vehicle travels over the bump, the vehicle initially experiences an upwardly directed first pitching motion; i.e., the pitch angle increases linearly. Pitch rate 500a increases abruptly to a positive value. Upon reaching the maximum pitch angle, pitch rate 500a is once again zero. While traveling over the highest point of the bump, the vehicle experiences a downwardly directed second pitching motion; i.e., the pitch angle decreases linearly. This corresponds to an abrupt drop in pitch rate 500a to a negative value. When the pitch angle is once again constant, pitch rate 500a is once again zero.

FIG. 5b shows a pitch rate 500b of the vehicle at high speed, for example twice as high as the speed in FIG. 5a. The respective steps of pitch rate 500b are several times higher than in FIG. 5a. In contrast, the steps shown in FIG. 5b are approximately one-half as short as in FIG. 5a. Pitch rate 500b corresponds to a much stronger and briefer pitching motion of the vehicle than pitch rate 500a.

Thus, different pitch rates of the vehicle result when the pitch angle curve is the same but the speeds are different.

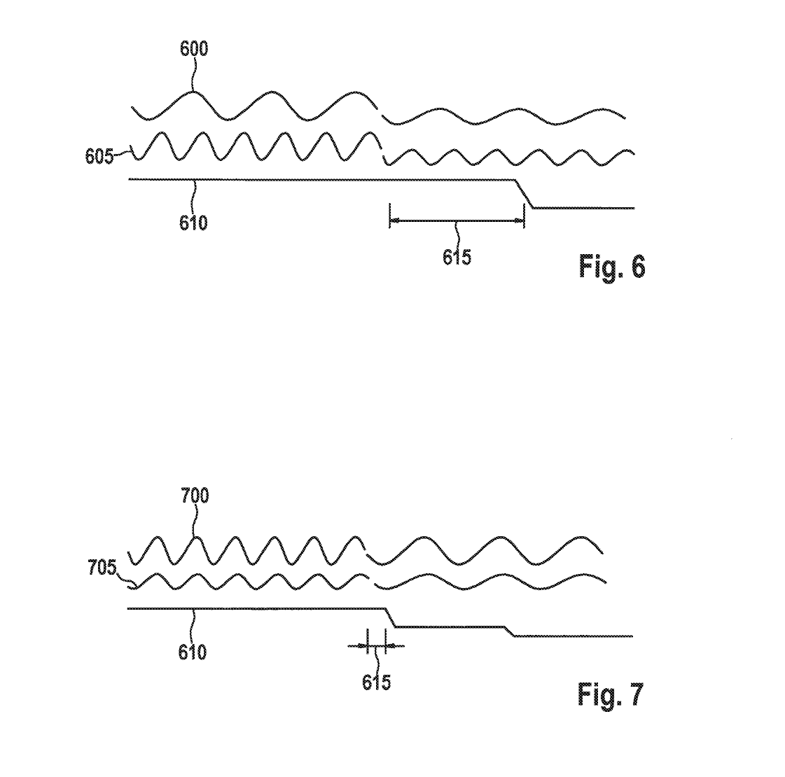

FIG. 6 shows a schematic illustration of a pitch angle curve and safety angle curve of a vehicle for various speeds and road qualities, according to a conventional method for ascertaining a safety angle. A first pitch angle curve 600 represents a pitch angle curve at low speed. A second pitch angle curve 605 represents a pitch angle curve at high speed. Pitch angle curves 600, 605 and safety angle curve 610 are illustrated one upon the other. Pitch angle curves 600, 605 are illustrated as waves; safety angle curve 610 is illustrated as a straight line. Pitch angle curves 600, 605 are divided into two segments. The first segment shows pitch angle curves 600, 605 or poor road quality. The second segment shows pitch angle curves 600, 605 for good road quality. An amplitude of first pitch angle curve 600 is at least approximately identical to an amplitude of second pitch angle curve 605. In contrast, the amplitudes of the second segment are much lower than the amplitudes of the first segment. A frequency of first pitch angle curve 600 is also much smaller than a frequency of second pitch angle curve 605. In contrast, the frequencies of the first segment are at least approximately identical to the frequencies of the second segment.

During the transition from the first to the second segment, i.e., from the poor to the good road quality, safety angle curve 610 initially remains unchanged during a response period 615. Response period 615 may correspond to a measuring period of up to 30 seconds, for example, which is necessary for detecting the new road quality. After response period 615 has elapsed, safety angle curve 610 drops sharply and then remains at a value which represents a smaller safety angle than in the first segment.

FIG. 7 shows a schematic illustration of a pitch angle curve and safety angle curve of a vehicle for various speeds and road qualities, according to one exemplary embodiment of the present invention. In contrast to FIG. 6, in FIG. 7 a first pitch angle curve 700 represents a pitch angle curve for poor road quality, and a second pitch angle curve 705 represents a pitch angle curve for good road quality. A first segment shows pitch angle curves 700, 705 at high speed. A second segment shows pitch angle curves 700, 705 at low speed. An amplitude of first pitch angle curve 700 is much larger than an amplitude of second pitch angle curve 705. In contrast, the amplitudes of the first segment are at least approximately identical to the amplitudes of the second segment. A frequency of first pitch angle curve 700 is also at least approximately identical to a frequency of second pitch angle curve 705. In contrast, the frequencies of the second segment are much smaller than the frequencies of the first segment.

In comparison to FIG. 6, response period 615 is much shorter during the transition from the first to the second segment, i.e., from the high to the low speed. According to one exemplary embodiment of the present invention, the shortened response period may be achieved by multiplying a reference value which represents the pitch angle curve by a speed value.

Safety angle curve 610 may drop an additional time after a further response period, for example when, in addition to the reduction in the speed, the road quality improves. The further response period may correspond to response period 615 shown in FIG. 6, since detecting the road quality may be much more time-consuming compared to adapting the safety angle to a change in speed.

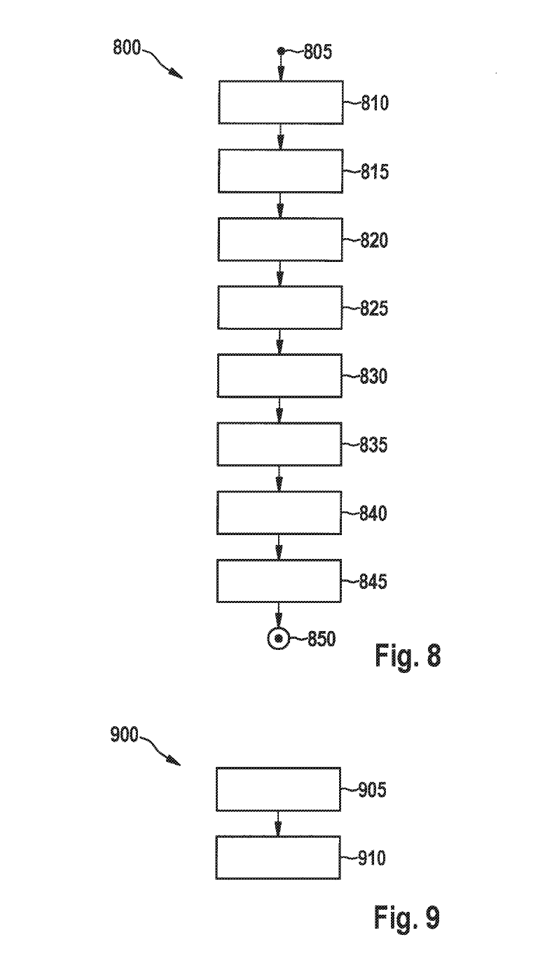

FIG. 8 shows a flow chart of a method 800 for ascertaining a safety angle according to one exemplary embodiment of the present invention. Method 800 is started with a step 805. A pitch rate and/or a pitch angle of the vehicle are/is initially ascertained in a step 810. A pitch angle deviation is subsequently ascertained in a step 815, using the pitch rate and/or the pitch angle. The pitch angle deviation is normalized to a speed of the vehicle in a step 820. The normalized pitch angle deviation is stored in a 20-second buffer in a step 825. A normalized safety value is ascertained in a step 825, using the values, stored in the 20-second buffer, which each represent a normalized pitch angle deviation. The normalized safety value is weighted with and/or multiplied by an instantaneous speed of the vehicle in a further step 830. A safety angle is computed in a step 835, using the weighted safety value. The safety angle may be limited in an optional step 845. In a step 850, the method 800 may be either terminated, or repeated in order to adapt the safety angle to a new speed and/or new road quality.

FIG. 9 shows a flow chart of a method 900 for ascertaining a safety angle according to one exemplary embodiment of the present invention. A speed value is read in in a step 905. The speed value may represent a speed of the vehicle, or the speed value may be a function of the speed of the vehicle. The safety angle is subsequently ascertained in a step 910, using the speed value.

One exemplary embodiment of the present invention is described once more below in a different way, with reference to FIGS. 1 through 8.

Depending on how fast a vehicle 105 is traveling over a road, a road quality of the road, also referred to as the reference value, may have different effects on a required safety angle 122 of a headlight 130. If vehicle 105 decelerates, safety angle 122 may be reduced, and a higher visual range may be set. If vehicle 105 accelerates, bumps have a greater effect on pitching of vehicle 105. Safety angle 122 should then be increased due to the higher risk of blinding.

In conventional methods, at a reduced speed, safety angle 122 is not reduced until a period of 20 seconds, for example, has elapsed. Due to a long evaluation period of the road quality, such systems are very sluggish, so that the visual range may be too low. The present invention provides a method for normalizing safety angle 122, which is a function of the road quality. The method may be used in particular in the context of a high beam assistant such as AHC. As a result of normalizing safety angle 122 to the speed when ascertaining the road quality, safety angle 122 may be adapted to the speed in a timely manner. The speed may also be referred to as speed value 120.

For determining safety angle 122, a pitch angle deviation within a certain time period is ascertained as the first step. A time period of 150 ms, for example, may reflect sluggishness of headlight 130. The pitch rate represents a change in pitch angle per unit of time:

$$\dot{α} = \frac{\partial α}{\partial t}$$

The pitch angle deviation represents a deviation within the period of 150 ms, for example:

$$\tilde{α} = \frac{Δ α}{Δ t} = \frac{{\int }_{t}^{t + Δ k} \dot{α}}{Δ t} = \frac{{\int }_{t}^{t + 150 ms} \dot{α}}{150 ms} = \frac{Δ α}{150 ms}$$

The pitch rate and the pitch angle deviation are expressed in units of degrees per second (°/s).

When a vehicle in principle experiences the same pitch pattern, regardless of the vehicle speed, when traveling over a road segment, it may be concluded that the pitch rate, and thus also the pitch angle deviation, is a function of the speed (see FIGS. 4a through 5b).

The pitch angle deviation is normally utilized to determine safety angle 122. If the pitch angle deviation (units: degrees per second) is normalized to the speed of the vehicle (units: meters per second) , this results in a unit which may satisfactorily describe a road quality Q:

$$Q = \frac{\tilde{α}}{v} \\ [ Q ] = \frac{[ \tilde{α} ]}{[ v ]} = \frac{° \text{/} s}{m \text{/} s} = \frac{°}{m}$$

The road quality thus obtained may be ascertained over a fairly long time period of 20 seconds, for example. Correct safety angle 122 may be ascertained at any point in time by multiplying by an instantaneous vehicle speed. An immediate response to a change in speed is thus possible.

Instead of normalizing to the speed, it is likewise possible to normalize to a value that is a function of the speed. Computing a division may take a very large amount of computing time, in particular on embedded systems. For example, a hardware implementation on a field programmable gate array (FPGA), a programmable logic gate system in the application field, requires a large amount of space. It is therefore advantageous when, instead of a division, a function is used which ascertains a correction factor from the speed. Expenditure of resources for the computation may be greatly reduced by resorting to a multiplication.

In computing the correction factor, functions may also be used which are designed for obtaining a slightly different behavior in the computation. For example, a factor may be ascertained which combines the advantages of a classical computation, such as a smooth response or robustness against rapid changes, with the advantage of the normalized road quality, a rapid response to a change in speed.

In addition, in computing safety angle 122, there is the option for multiplying the normalized pitch angle deviation or road quality Q not by the speed, but, rather, by a speed-dependent factor.

It is also advantageous when safety angle 122 and/or the speed-dependent factor, i.e., the speed by which the normalized pitch angle deviation is multiplied, are/is limited after the computation (to no lower than a minimum, and to no higher than a maximum). When there are excessively large speed differences between an analysis of the road quality, which may be up to 20 seconds old, for example, and an actual speed, influences due to measuring inaccuracies and/or deviations may thus be prevented from being too highly weighted in the ascertainment.

The exemplary embodiments which are described, and shown in the figures, have been selected only as examples. Different exemplary embodiments may be combined with one another, either completely or with respect to individual features. In addition, one exemplary embodiment may be supplemented by features of another exemplary embodiment.

Moreover, method steps according to the present invention may be carried out repeatedly, as well as in a sequence other than that described.

If an exemplary embodiment includes an “and/or” linkage between a first feature and a second feature, this may be construed in such a way that according to one specific embodiment, the exemplary embodiment has the first feature as well as the second feature, and according to another specific embodiment, the exemplary embodiment either has only the first feature or only the second feature.

1-9. (canceled)

10. A method for ascertaining a safety angle of a headlight beam of at least one headlight of a host vehicle, the safety angle representing a vertical angle by which the headlight beam is lowered to a safety height, the safety height representing a height of the headlight beam at which no blinding of a driver of another vehicle occurs, the method comprising:
reading in a speed value which is a function of a speed of the host vehicle; and
ascertaining the safety angle as a function of the speed value.

11. The method as recited in claim 10, further comprising:
determining a reference value as a function of a pitch angle of the vehicle;
wherein the safety angle is ascertained additionally as a function of the reference value.

12. The method as recited in claim 11, wherein the reference value is at least one of (i) multiplied by the speed value, and (ii) weighted with the speed value, in the step of ascertaining in order to ascertain the safety angle.

13. The method as recited in claim 12, wherein the reference value is determined additionally as a function of at least one of a pitch rate and a change in pitch angle of the vehicle.

14. The method as recited in claim 12, wherein a further speed value is read in in the step of reading in, the further speed value representing a further speed of the vehicle, and wherein the reference value is normalized to the further speed value.

15. The method as recited in claim 12, wherein the reference value is determined using multiple base values which are detected during a predetermined time period and which are a function of the pitch angle.

16. The method as recited in claim 12, wherein the safety angle is ascertained taking into account at least one of a minimum safety angle, a maximum safety angle, a minimum speed value, and a maximum speed value.

17. A device for ascertaining a safety angle of a headlight beam of at least one headlight of a host vehicle, the safety angle representing a vertical angle by which the headlight beam is lowered to a safety height, the safety height representing a height of the headlight beam at which no blinding of a driver of another vehicle occurs, the device comprising:
a reading-in unit configured to read in a speed value, which is a function of a speed of the host vehicle; and
an ascertainment unit configured to ascertain the safety angle as a function of the speed value.

18. A non-transitory, computer-readable data storage medium storing a computer program having program codes which, when executed on a computer, perform a method for ascertaining a safety angle of a headlight beam of at least one headlight of a host vehicle, the safety angle representing a vertical angle by which the headlight beam is lowered to a safety height, the safety height representing a height of the headlight beam at which no blinding of a driver of another vehicle occurs, the method comprising:
reading in a speed value which is a function of a speed of the host vehicle; and
ascertaining the safety angle as a function of the speed value.
